(19) United States
(12) Patent Application Publication
(10) Pub. No.: US 2009/0259359 A1
(43) Pub. Date: Oct. 15, 2009

(54) VARIABLE INTENSITY HAPTIC LEVEL CONTROL BASED ON VEHICLE CONDITIONS

(76) Inventors: David Michael Whitton, Saline, MI (US); Douglas Allen Pfau, Canton, MI (US)

Correspondence Address: FRASER CLEMENS MARTIN & MILLER LLC, 28366 KENSINGTON LANE, PERRYSBURG, OH, 43551, US

(21) Appl. No.: 12/099,990

(22) Filed: Apr. 9, 2008

(51) Int. Cl. G06F 17/00

(52) U.S. Cl. 701/33; 701/29

(57) ABSTRACT

A haptic control system and a method for controlling a tactile feedback, wherein the haptic control system and the method control the tactile feedback in response to a vehicle condition, are disclosed. The haptic control system for a vehicle includes a vehicle information system adapted to generate and transmit a vehicle information signal including data and information representing a vehicle condition and a controller adapted to receive the vehicle information signal, analyze the vehicle information signal, and generate and transmit a control signal for controlling a tactile feedback in response to the vehicle information signal.

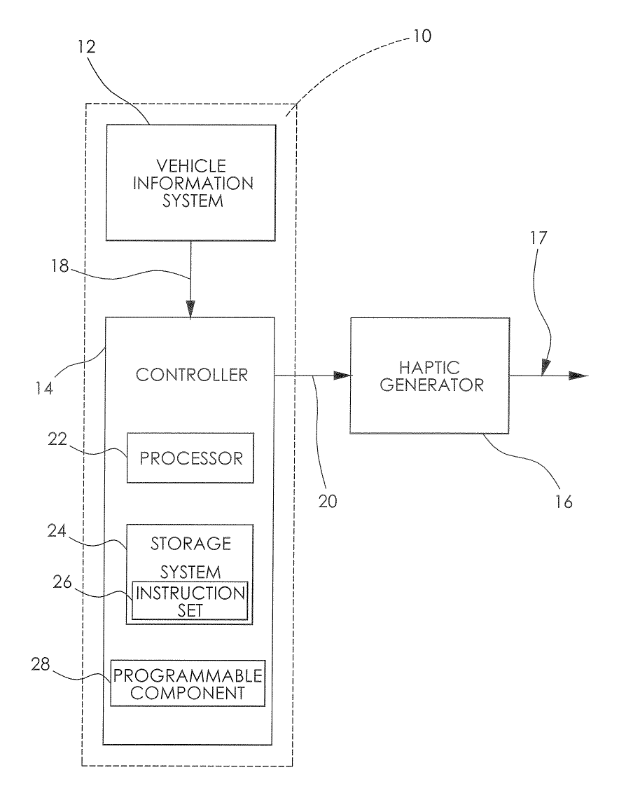

### FIELD OF THE INVENTION

The present invention relates to haptics. More particularly, the invention is directed to a haptic control system for a vehicle and a method for controlling a tactile feedback.

### BACKGROUND OF THE INVENTION

Haptic technology refers to technology which interfaces the user via the sense of touch by applying forces, vibrations, and/or motions to the user. This mechanical stimulation may be used to supply a tactile feedback to the user of a vehicle or other machine to indicate the operational status or condition of the vehicle or machine. With the introduction of user haptics generated by vibratory and motor controlled surface motions, there currently exists no way to take vehicle conditions into account when generating the tactile feedback. For example, where a vehicle is traveling on rough terrain, the ambient vibrations of the vehicle may reduce the vibratory sensation of the generated tactile feedback.

It would be desirable to have a haptic control system and a method for controlling a tactile feedback, wherein the haptic control system and the method control the tactile feedback in response to a vehicle condition.

### SUMMARY OF THE INVENTION

Concordant and consistent with the present invention, a haptic control system and a method for controlling a tactile feedback, wherein the haptic control system and the method control the tactile feedback in response to a vehicle condition, has surprisingly been discovered.

In one embodiment, a haptic control system for a vehicle comprises a vehicle information system adapted to generate and transmit a vehicle information signal including data and information representing a vehicle condition and a controller adapted to receive the vehicle information signal, analyze the vehicle information signal, and generate and transmit a control signal for controlling a tactile feedback in response to the vehicle information signal.

In another embodiment, a haptic control system for a vehicle comprises a vehicle information system adapted to generate and transmit a vehicle information signal including data and information representing a vehicle condition, a controller adapted to receive the vehicle information signal, analyze the vehicle information signal, and generate and transmit a control signal in response to the vehicle information signal, and a haptic generator adapted to receive the control signal and generate a tactile feedback to a user in response to the control signal.

The invention also provides methods for controlling a tactile feedback.

One method comprises the steps of: retrieving data and information representing at least one vehicle condition; generating a vehicle information signal including data and information representing at least one vehicle condition; analyzing the vehicle information signal; generating a control signal in response to the vehicle information signal; and generating a tactile feedback to a user in response to the control signal.

### BRIEF DESCRIPTION OF THE DRAWINGS

The above, as well as other advantages of the present invention, will become readily apparent to those skilled in the art from the following detailed description of the preferred embodiment when considered in the light of the accompanying drawing which is a schematic block diagram of a haptic control system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Referring to the FIGURE, there is illustrated a haptic control system 10 according to the present invention. The haptic control system 10 includes a vehicle information system 12, and a controller 14. It is understood that the haptic control system 10 may be installed in a vehicle during a manufacturing process of the vehicle. It is further understood that the haptic control system 10 may be installed in the vehicle by a post-production process. As shown, the haptic control system 10 is in communication with a haptic generator 16. It is understood that the haptic generator 16 may be any haptic device or haptic system adapted to produce a tactile feedback 17 to a user. As a non-limiting example, the haptic generator 16 may provide a variable tactile feedback to a user interface such as a steering wheel, a touch screen, a control button, and a rotary knob, for example. Other user interfaces may be used, as desired. It is further understood that the tactile feedback 17 generated by the haptic generator 16 may include a variable frequency, a variable amplitude, and a variable pulse pattern, for example. Other dynamic tactile feedback sensations may be provided to the user by the haptic generator 16, as desired.

The vehicle information system 12 is adapted to transmit a vehicle information signal 18 to the controller 14. The vehicle information signal 18 may include data and information from a variety of vehicle systems such as a suspension system, a braking system, a speedometer, a tachometer, a radio, and an electronic window control system, for example. The vehicle information signal 18 may include data and information from other systems, as desired. It is understood that the vehicle information system 12 may include sensors (not shown) that directly measure a particular vehicle condition and transmit the vehicle information signal 18 to the controller 14. It is further understood that the vehicle information system 12 may be in communication with a secondary vehicle system (not shown), wherein the vehicle information system 12 is adapted to retrieve a desired data from the secondary vehicle system, the desired data corresponding to a vehicle condition. As a non-limiting example, the vehicle may have an electronic module that measures the activity of the vehicle suspension system. As such, the vehicle information system 12 receives the suspension data measured by the electronic module and transmits the vehicle information signal 18 including the suspension data to the controller 14. It is understood that the vehicle may have any number of secondary vehicle systems and measurement systems, as desired. It is further understood that the vehicle information system 12 may be adapted to measure any vehicle condition, as desired.

The controller 14 is adapted to receive the vehicle information signal 18, analyze the vehicle information signal 18, and transmit a control signal 20 to the haptic generator 16 in response to the analysis of the vehicle information signal 18. The controller 14 may be any device adapted to receive the vehicle information signal 18, analyze the vehicle information signal 18, and transmit the control signal 20 such as a microcomputer, for example. Other devices may be used, as appropriate.

In one embodiment, the controller 14 includes a processor 22 and a storage system 24. The processor 22 is adapted to analyze the vehicle information signal 18 based upon an instruction set 26. The instruction set 26, which may be embodied within any computer readable medium, includes processor executable instructions for configuring the processor 22 to perform a variety of tasks. The storage system 24 may be a single storage device or may be multiple storage devices. Portions of the storage system 24 may also be located on the processor 22. Furthermore, the storage system 24 may be a solid state storage system, a magnetic storage system, an optical storage system or any other suitable storage system. It is understood that the storage system 24 is adapted to store the instruction set 26. Other data and information may be stored in the storage system 24, as desired.

The controller 14 may further include a programmable component 28. The programmable component 28 is in communication with the processor 22. It is understood that the programmable component 28 may be in communication with any other component of the haptic control system 10 such as the vehicle information system 12 and the storage system 24, for example. In certain embodiments, the programmable component 28 is adapted to manage and control processing functions of the processor 22. Specifically, the programmable component 28 is adapted to control the analysis of the vehicle information signal 18 and the generation and transmission of the control signal 20. The programmable component 28 provides a means for a user to actively manage the operation of the processor 22 and thereby control the resultant tactile feedback effect generated by the haptic generator 16. It is understood that the programmable component 28 may be adapted to manage and control the vehicle information system 12. It is further understood that the programmable component 28 may be adapted to store data and information on the storage system 24 and retrieve data and information from the storage system 24.

In use, the vehicle information system 12 transmits the vehicle information signal 18 to the controller 14. As a non-limiting example, the vehicle information signal 18 may include data and information representing the vehicle suspension system. Specifically, the vehicle information signal 18 may include data representing that the vehicle is traveling over rough road conditions, as evident by an increase in vehicle suspension activity. It is understood that the vehicle information signal 18 may include data and information relating to any vehicle system such as a braking system, a speedometer, a tachometer, a radio, and an electronic window control system, for example. The controller 14 receives the vehicle information signal 18 and analyzes the vehicle information signal 18. In one embodiment, the processor 22 analyzes the vehicle information signal 18 based upon the pre-programmed instruction set 26. It is understood that the instruction set 26 may be altered by the user, thereby modifying the desired analysis of the vehicle information signal 18 and the generation of the resultant control signal 20. It is further understood that the user may configure the processor 22 and the instruction set 26 through the programmable component 28. Once the vehicle information signal 18 is analyzed, the controller 14 transmits a control signal 20 to the haptic generator 16. The control signal 20 includes data and information for controlling the tactile feedback 17 generated by the haptic generator 16. It is understood that the control signal 20 is adapted to be received by the haptic generator 16. It is further understood that the control signal 20 may be adapted to be received by any haptic system of the vehicle, as desired. As a non-limiting example, the control signal 20 may increase the frequency and/or intensity of the tactile feedback 17 generated by the haptic generator 16 to compensate for rough road conditions. As another non-limiting example, the controller 14 may transmit the control signal 20 to vary the pulse rate of the tactile feedback generated by the haptic generator 16 to compensate for ambient noise and vibration due to an opened window of the vehicle. It is understood that the control signal 20 may control any desired function of the haptic generator 16 or haptic system, as desired. It is further understood that the control signal 20 may be adapted to control the haptic generator 16 in response to any vehicle condition, as desired.

The haptic control system 10 and the method for controlling the tactile feedback 17 provide a variable tactile sensation to the user in response to a condition of the vehicle. The tactile feedback 17 is responsive to at least one condition of the vehicle, which further distinguishes the tactile feedback 17 from ambient noise and vibration.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A haptic control system for a vehicle comprising:
a vehicle information system adapted to generate and transmit a vehicle information signal including data and information representing a vehicle condition; and
a controller adapted to receive the vehicle information signal, analyze the vehicle information signal, and generate and transmit a control signal for controlling a tactile feedback in response to the vehicle information signal.

2. The haptic control system according to claim 1, further comprising a haptic generator adapted to receive the control signal and generate a tactile feedback to a user in response to the control signal.

3. The haptic control system according to claim 1, wherein the controller includes a processor adapted to analyze the vehicle information signal.

4. The haptic control system according to claim 3, wherein the controller includes an instruction set having processor executable instructions for configuring the processor to perform the analysis of the vehicle information signal.

5. The haptic control system according to claim 1, wherein the controller includes a storage system for storing data and information.

6. The haptic control system according to claim 1, wherein the controller includes a programmable component adapted to provide user-controlled management of the vehicle information system.

7. The haptic control system according to claim 1, wherein the tactile feedback is controlled to distinguish the tactile feedback from ambient noise and vibration.

8. A haptic control system for a vehicle comprising:
a vehicle information system adapted to generate and transmit a vehicle information signal including data and information representing a vehicle condition;
a controller adapted to receive the vehicle information signal, analyze the vehicle information signal, and generate and transmit a control signal in response to the vehicle information signal; and
a haptic generator adapted to receive the control signal and generate a tactile feedback to a user in response to the control signal.

9. The haptic control system according to claim 8, wherein the controller includes a processor adapted to analyze the vehicle information signal.

10. The haptic control system according to claim 9, wherein the controller includes an instruction set having processor executable instructions for configuring the processor to perform the analysis of the vehicle information signal.

11. The haptic control system according to claim 8, wherein the controller includes a storage system for storing data and information.

12. The haptic control system according to claim 8, wherein the controller includes a programmable component adapted to provide user-controlled management of the vehicle information system.

13. The haptic control system according to claim 8, wherein the tactile feedback is controlled to distinguish the tactile feedback from ambient noise and vibration.

14. A method for controlling a tactile feedback, the method comprising the steps of:
retrieving data and information representing at least one vehicle condition;
generating a vehicle information signal including the data and information representing the at least one vehicle condition;
analyzing the vehicle information signal;
generating a control signal in response to the vehicle information signal; and
generating a tactile feedback to a user in response to the control signal.

15. The method according to claim 14, wherein the vehicle information signal is generated by a vehicle information system adapted to retrieve data and information representing at least one vehicle condition.

16. The method according to claim 15, wherein the step of analyzing the vehicle information signal is performed by a controller adapted to receive the vehicle information signal, analyze the vehicle information signal, and generate and transmit the control signal for controlling the tactile feedback.

17. The method according to claim 16, wherein the controller includes a processor adapted to analyze the vehicle information signal.

18. The method according to claim 17, wherein the controller includes an instruction set having processor executable instructions for configuring the processor to perform the analysis of the vehicle information signal

19. The method according to claim 16, wherein the controller includes a programmable component adapted to provide user-controlled management of the controller and the vehicle information system.

20. The method according to claim 14, wherein the tactile feedback is controlled to distinguish the tactile feedback from ambient noise and vibration.
